(19) United States
(12) Patent Application Publication
(10) Pub. No.: US 2013/0153616 A1
(43) Pub. Date: Jun. 20, 2013

(54) Weight-Bearing Frame For Hand-Propelled Cart

(71) Applicants: Rafi Geva, Shoham (IL); David Chiche, Shoham (IL)

(72) Inventors: Rafi Geva, Shoham (IL); David Chiche, Shoham (IL)

(73) Assignee: GREENCART INT LTD., Airport City (IL)

(21) Appl. No.: 13/820,513

(22) PCT Filed: Sep. 1, 2011
(86) PCT No.: PCT/IB2011/053833

§ 371 Date: Mar. 3, 2013

Related U.S. Application Data
(60) Provisional application No. 61/380,643, filed on Sep. 7, 2010.

(51) Int. Cl. B60R 11/00

(52) U.S. Cl. CPC B60R 11/00
USPC 224/401

(57) ABSTRACT

A weight-bearing accessory for a hand-propelled cart having a diagonal chassis includes a frame, which is configured to receive and hold one or more containers within the frame. At least one first quick-connect is configured to removably connect the first end of the frame to an upper part of the diagonal chassis. A first strut is coupled to support the second end of the frame. A second strut is connected to a joint at the lower end of the first strut. At least one second quick-connect is configured to removably connect the distal end of the second strut to a lower part of the diagonal chassis. The accessory is designed to fold easily and conveniently when not in use, while the structure of the accessory and the support that it provides prevent the cart from tipping over, regardless of the distribution of the weight carried by the accessory.

### CROSS-REFERENCE TO RELATED APPLICATIONS

This application claims the benefit of U.S. Provisional Patent Application 61/380,643, filed Sep. 7, 2010, which is incorporated herein by reference.

### FIELD OF THE INVENTION

The present invention relates generally to hand-propelled vehicles, and specifically to accessories for such vehicles.

### BACKGROUND

Modern baby strollers are typically built on a diagonal chassis, of a generally triangular shape. The chassis is “diagonal” in that the upper part of the chassis is inclined relative to the horizontal, typically by at least 30° (and more commonly around 45°). This sort of diagonal chassis is well adapted for mounting a baby seat and also folds easily and compactly. Sophisticated models permit the baby seat to be removed and may accept a specially-designed bassinette in its place.

PCT International Publication WO 2010/100583 describes a modular, foldable shopping cart, which includes a plurality of removable baskets. A foldable frame of the cart includes multiple wheels and an upper supporting structure, which is capable, when the frame is in its unfolded configuration, of supporting the baskets side-by-side by their respective rims.

### SUMMARY

Embodiments of the present invention that are described hereinbelow provide a weight-bearing accessory that can be mounted on a hand-propelled cart.

There is therefore provided, in accordance with an embodiment of the present invention, a weight-bearing accessory for a hand-propelled cart having a diagonal chassis. The accessory includes a frame, which has first and second ends and is configured to receive and hold one or more containers within the frame. At least one first quick-connect is configured to removably connect the first end of the frame to an upper part of the diagonal chassis. A first strut, having a lower end and an upper end, is coupled to support the second end of the frame. A second strut, having a distal end and a proximal end, is connected to a joint at the lower end of the first strut. At least one second quick-connect is configured to removably connect the distal end of the second strut to a lower part of the diagonal chassis.

In a disclosed embodiment, the frame includes a telescopic connection between the second end and the first end, which enables a length of the frame between the first and second ends to be adjusted. Additionally or alternatively, the at least one first quick connect includes two quick connects, which are configured to connect opposing sides of the first end of the frame to corresponding locations on the diagonal chassis in proximity to a handle of the cart.

In some embodiments, the joint is configured to rotate between locked and folded positions, wherein the first and second struts are configured, while the joint is in the locked position, to hold the frame in a horizontal orientation, and wherein the frame is collapsed against the diagonal chassis when the joint is rotated to the folded position. The at least one second quick-connect may include upper and lower quick-connects, which are positioned at respective upper and lower locations along a length of the second strut, and which are configured to connect respectively to upper and lower crossbars in the lower part of the diagonal chassis when the joint is in the locked position. The upper quick-connect may be disconnected from the upper crossbar when the joint is rotated to the folded position while the lower quick-connect remains connected to and rotates about the lower crossbar. Additionally or alternatively, at least the upper quick-connect is movable along the second strut between the proximal and distal ends so as to adjust for a distance between the upper and lower crossbars.

There is also provided, in accordance with an embodiment of the present invention, a method for operating a hand-propelled cart having a diagonal chassis. The method includes removably connecting a first end of a frame to an upper part of the diagonal chassis using at least one first quick-connect, wherein a second end of the frame is coupled to be supported by an upper end of a first strut. A distal end of a second strut is removably connected to a lower part of the diagonal chassis using at least one second quick-connect, wherein a proximal end of the second strut is connect by a joint to the lower end of the first strut. One or more containers are inserted to be carried within the frame.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a cart with a weight-bearing accessory mounted thereon, in accordance with an embodiment of the present invention;

FIG. 2 is a schematic, pictorial illustration of the accessory of FIG. 1;

FIG. 3 is a schematic side view of the accessory of FIG. 1; and

FIGS. 4A-4C are schematic side views of a weight-bearing accessory mounted on a cart, in successive stages of folding the accessory, in accordance with an embodiment of the present invention.

### DETAILED DESCRIPTION OF EMBODIMENTS

In general, strollers and other sorts of vehicles with diagonal chassis do not have any sort of weight-bearing horizontal superstructure above the chassis. Embodiments of the present invention that are described below provide an accessory that can serve this purpose and thus enhance the utility of such vehicles. The accessory is designed to be folded easily and conveniently when not in use. At the same time, the structure of the accessory, as described below, and the support that it provides are such as to prevent the vehicle from tipping over, regardless of the distribution of the weight carried by the accessory (whether near the handle of the vehicle or at the opposite end).

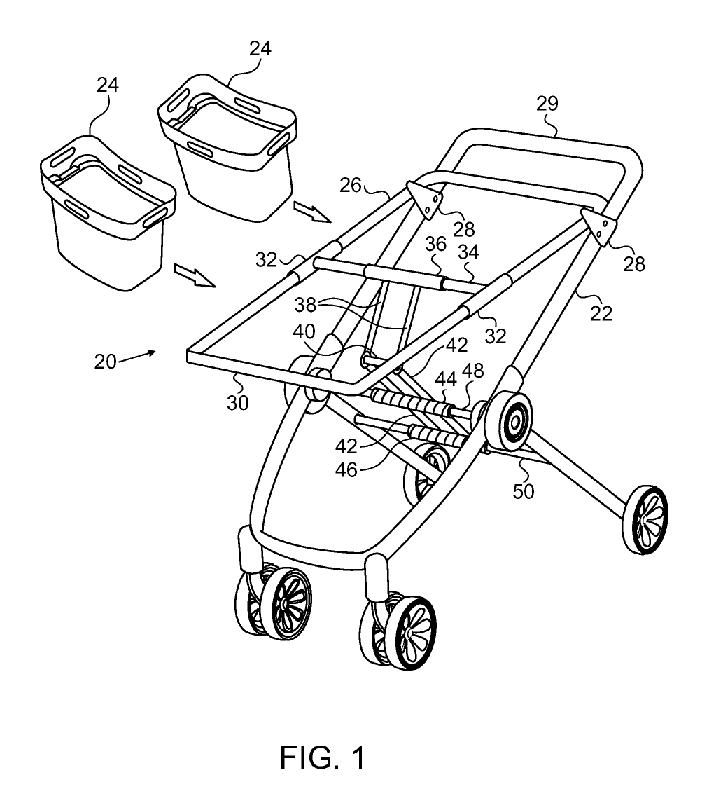

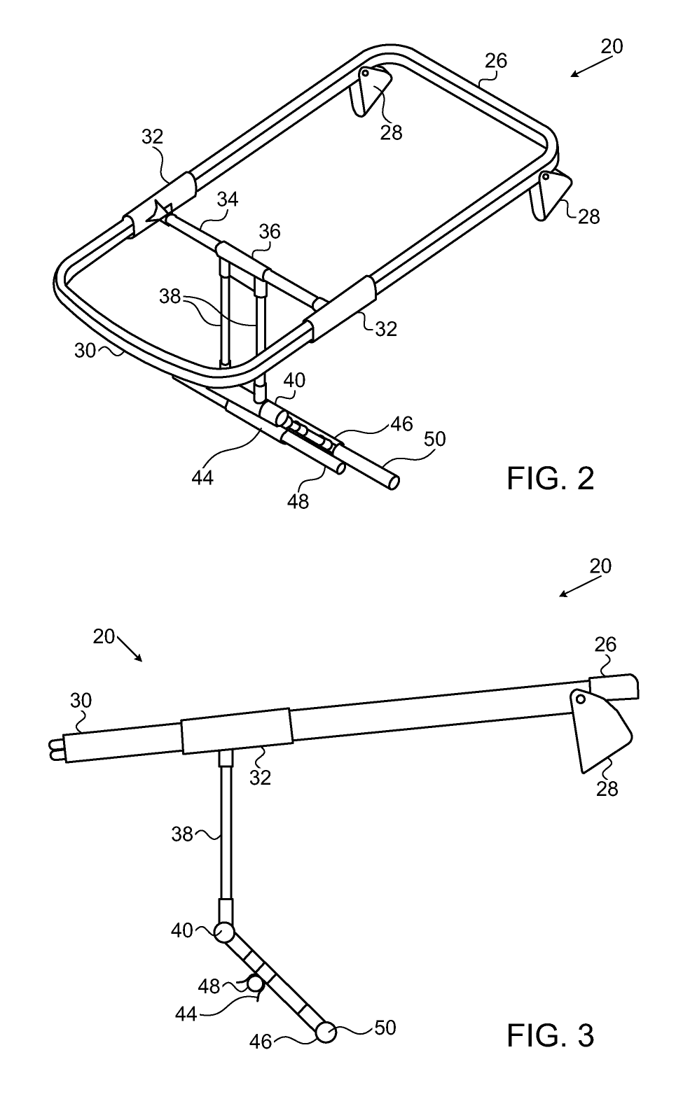

Reference is now made to FIGS. 1-3, which schematically illustrate a weight-bearing accessory 20 for mounting on a diagonal chassis 22 of a cart, in accordance with an embodiment of the present invention. FIG. 1 is a pictorial illustration showing accessory 20 mounted on the cart, while FIGS. 2 and 3 show the accessory itself in pictorial and side views, respectively. Chassis 22 is this example belongs to a baby stroller, from which the seat has been removed, but accessory 20 is adaptable for mounting on a wide range of different sorts of hand-propelled vehicles with diagonal chassis.

Accessory 20 comprises a frame 26, which has a horizontal orientation when the accessory is mounted on chassis 22. (The term “horizontal” is used in this context to refer to planes that within 10° of the plane of the wheelbase of the chassis.) Frame 26 is configured to receive and hold one or more containers 24 within the frame. In the pictured example, containers 24 have rims that are sized to rest on frame 26, but the frame can alternatively support other sorts of containers, such as bags or boxes, as well as special-purpose containers, such as a child seat. The user may insert and remove these various sorts of containers freely as required, either within the frame or resting on the frame. A front end 30 of frame 26 is coupled by a telescopic connection to the rear end, so that the length of the frame between the front and rear ends can be adjusted for loads of different sizes.

Frame 26 and the remaining parts of accessory 20 are made to support substantial weights—typically up to 100 kg—depending on the weight-bearing capability of the cart on which the accessory is mounted. The components of accessory 20 are made for this purpose from strong, lightweight materials, such as metal alloys, suitable plastics, or compound materials, for example. For compact storage and transportation of accessory 20, front end 30 slides into connection 32, and the elements that support frame 26 (described below) fold flat against the frame. Thus, accessory 20 conveniently enhances the usefulness and versatility of baby strollers and other carts.

Accessory 20 is removably attached to chassis 22 by quick-connects 28, 44 and 46. The term “quick-connect” is used, in the context of the present description and in the claims, to refer to connectors that can be readily attached and detached by hand or using a hand tool, without the need for drilling, welding or cutting and without damage to the chassis. These quick-connects enable the user to quickly and easily mount accessory 20 on chassis 22 and to remove the accessory when it is not needed.

To support frame 26, two quick-connects 28 connect the opposing sides of the rear end of the frame to corresponding locations on chassis 22, in proximity to a handle 29 of the cart. Front end 30 of the frame is support by upper struts 38, which are connected at their upper ends to a rotatable coupling 36 on a cross-bar 34 of the frame. The lower ends of upper struts 38 are connected by a rotatable joint 40 to the proximal ends of lower struts 42. These lower struts are connected by quick-connects 44 and 46 to respective crossbars 48 and 50 of chassis 22, and thus support and hold upper struts in place. (Terms such as “first,” “second,” “proximal,” and “distal” are used for convenience in distinguishing different parts of accessory 20 and do not have functional meaning unless the context indicates otherwise.)

It can be seen by study of the figures that lower quick-connect 46 at the end of struts 42 on crossbar 50 would be sufficient to hold struts 38 and 42 and frame 26 in place. The addition of upper quick-connect 44 along the length of struts 42 adds stability, however. Quick-connect 44 may be movable along struts 42 between the proximal and distal ends so as to adjust for different distances between upper and lower crossbars 48 and 50 on different types of chassis. Quick-connect 44 may be a snap-on type connector, so as to facilitate disconnection of the quick-connect from crossbar 48 when accessory 20 is folded down, as described below, as well as reconnection when the accessory is folded back up.

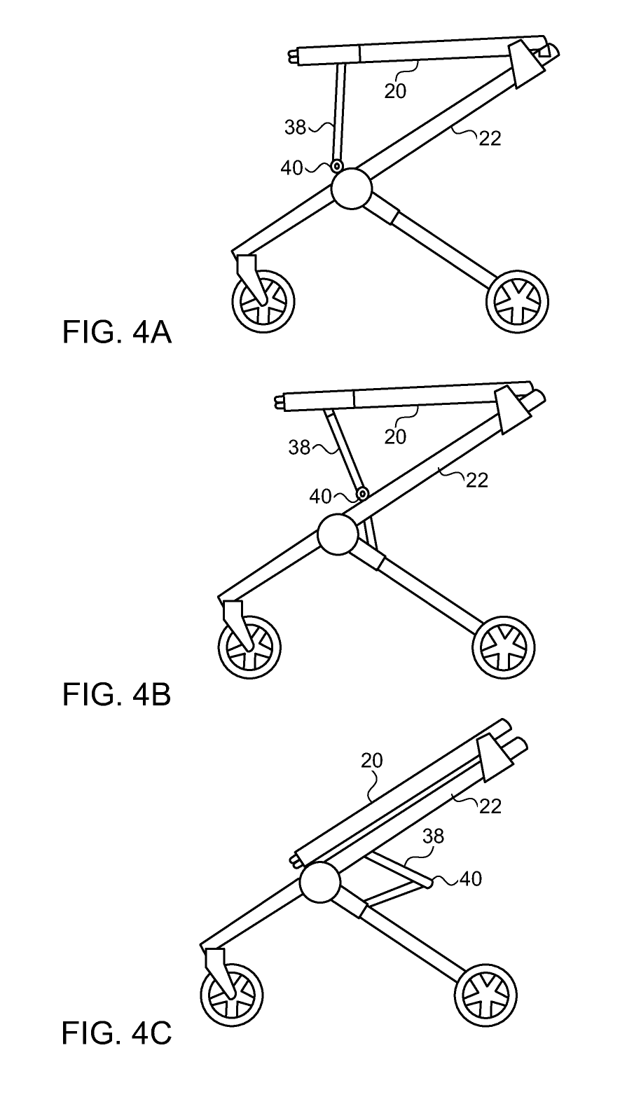

FIGS. 4A-4C are schematic side views of accessory 20 mounted on chassis 22, in successive stages of folding the accessory, in accordance with an embodiment of the present invention. As not all of the elements of accessory 20 and chassis 22 can be seen in FIGS. 4A-4C, the description that follows refers, as well, to the elements that are pictured in FIGS. 1-3.

As long as accessory 20 is fully assembled and ready for use, as shown in FIG. 1, joint 40 is rotated forward to a locked position, in which upper quick-connect 44 is closed against crossbar 48 and struts 38 bear the full weight of frame 26 against chassis 22. To fold accessory 20, front end 30 may first be pushed into telescopic connection 32, as shown in FIG. 4A. Joint 40 is then rotated backward, as shown in FIG. 4B, while upper quick-connect 44 is disconnected from crossbar 48. Meanwhile, lower quick-connect 46 rotates about lower crossbar 50. Finally, as shown in FIG. 4C, joint 40 is rotated back to a folded position, in which frame 26 is collapsed against chassis 22. Chassis 22 may be folded up, as well, so that the accessory and chassis may be stored and transported together in a compacted, folded configuration.

Although for the sake of clarity and concreteness a particular mechanical design has been shown and described above, alternative designs implementing the principles of the present invention will be apparent to those skilled in the art after reading the description and are considered to be within the scope of the present invention. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A weight-bearing accessory for a hand-propelled cart having a diagonal chassis, the accessory comprising:
a frame, which has first and second ends and is configured to receive and hold one or more containers within the frame;
at least one first quick-connect, which is configured to removably connect the first end of the frame to an upper part of the diagonal chassis;
a first strut, having a lower end and an upper end, which is coupled to support the second end of the frame;
a joint at the lower end of the first strut;
a second strut, having a distal end and a proximal end, which is connected to the joint so as to support the first strut; and
at least one second quick-connect, which is configured to removably connect the distal end of the second strut to a lower part of the diagonal chassis.

2. The accessory according to claim 1, wherein the frame comprises a telescopic connection between the second end and the first end, which enables a length of the frame between the first and second ends to be adjusted.

3. The accessory according to claim 1, wherein the at least one first quick connect comprises two quick connects, which are configured to connect opposing sides of the first end of the frame to corresponding locations on the diagonal chassis in proximity to a handle of the cart.

4. The accessory according to claim 1, wherein the joint is configured to rotate between locked and folded positions, wherein the first and second struts are configured, while the joint is in the locked position, to hold the frame in a horizontal orientation, and wherein the frame is collapsed against the diagonal chassis when the joint is rotated to the folded position.

5. The accessory according to claim 4, wherein the at least one second quick-connect comprises upper and lower quick-connects, which are positioned at respective upper and lower locations along a length of the second strut, and which are configured to connect respectively to upper and lower crossbars in the lower part of the diagonal chassis when the joint is in the locked position.

6. The accessory according to claim 5, wherein the upper quick-connect is disconnected from the upper crossbar when the joint is rotated to the folded position while the lower quick-connect remains connected to and rotates about the lower crossbar.

7. The accessory according to claim 5, wherein at least the upper quick-connect is movable along the second strut between the proximal and distal ends so as to adjust for a distance between the upper and lower crossbars.

8. A method for operating a hand-propelled cart having a diagonal chassis, the method comprising:
removably connecting a first end of a frame to an upper part of the diagonal chassis using at least one first quick-connect, wherein a second end of the frame is coupled to be supported by an upper end of a first strut;
removably connecting a distal end of a second strut to a lower part of the diagonal chassis using at least one second quick-connect, wherein a proximal end of the second strut is connect by a joint to the lower end of the first strut; and
inserting one or more containers to be carried within the frame.

9. The method according to claim 8, and comprising adjusting a length of the frame between the first and second ends using a telescopic connection between the second end and the first end.

10. The method according to claim 8, wherein removably connecting the first end comprises connecting two quick connects at opposing sides of the first end of the frame to corresponding locations on the diagonal chassis in proximity to a handle of the cart.

11. The method according to claim 8, and comprising rotating the joint between locked and folded positions, wherein the first and second struts are configured, while the joint is in the locked position, to hold the frame in a horizontal orientation, and wherein the frame is collapsed against the diagonal chassis when the joint is rotated to the folded position.

12. The method according to claim 11, wherein the at least one second quick-connect comprises upper and lower quick-connects, which are positioned at respective upper and lower locations along a length of the second strut, and which are configured to connect respectively to upper and lower crossbars in the lower part of the diagonal chassis when the joint is in the locked position.

13. The method according to claim 12, wherein the upper quick-connect is disconnected from the upper crossbar when the joint is rotated to the folded position while the lower quick-connect remains connected to and rotates about the lower crossbar.

14. The method according to claim 12, and comprising moving the upper quick-connect along the second strut between the proximal and distal ends so as to adjust for a distance between the upper and lower crossbars.
